(19) United States
(12) Patent Application Publication
(10) Pub. No.: US 2018/0194345 A1
(43) Pub. Date: Jul. 12, 2018

(54) MOBILE TERMINAL DEVICE FOR USE WITH A VEHICLE

(71) Applicant: FORD GLOBAL TECHNOLOGIES, LLC, Dearborn, MI (US)

(72) Inventors: Frederic STEFAN, Aachen NRW (DE); Christoph ARNDT, Moerlen Rheinland-Pfalz (DE); Uwe GUSSEN, Huertgenwald NRW (DE)

(73) Assignee: FORD GLOBAL TECHNOLOGIES, LLC, Dearborn, MI (US)

(21) Appl. No.: 15/852,455

(22) Filed: Dec. 22, 2017

(30) Foreign Application Priority Data
Jan. 9, 2017 (DE) 10 2017 200 148.8

(51) Int. Cl. B60W 30/06; G05D 1/02; G08G 1/16

(52) U.S. Cl. CPC B60W 30/06; G08G 1/168; G05D 1/021

(57) ABSTRACT

A method is proposed that uses sensors of a mobile terminal device with a vehicle. The method includes deploying a mobile terminal with sensors, deploying a vehicle having positioning facilities for the mobile terminal device in or on the vehicle and a processing unit. The method connects the processing unit to the mobile terminal device, and identifies the mobile terminal device through the processing unit. The processing unit proposes positioning facilities for the mobile terminal device in or on the vehicle, as well as sensors that can be used depending on the mobile terminal device identified through the processing unit. The method also includes processing the transmitted measurements through the processing unit to execute a parking maneuver.

### CROSS-REFERENCE TO RELATED APPLICATIONS

This application claims foreign priority benefits under 35 U.S.C. § 119(a)-(d) to DE 102017200148.8 filed Jan. 9, 2017, which is hereby incorporated by reference in its entirety.

### TECHNICAL FIELD

The disclosure relates to a vehicle communicable with sensors of a mobile terminal device, a computer program and a computer readable storage medium.

### BACKGROUND

The automation of ever more vehicle functions has increased the demand for suitable sensors, such as image sensors for cameras or LIDAR sensors. The integration of such sensors into a vehicle is usually associated with additional costs and energy consumption, and the need for a suitable electrical and mechanical connection (wiring, mounting, etc.).

In addition, such sensors are subject to aging phenomena, in other words, their sensor behavior changes or degrades after a certain period of time, for example due to the influence of environmental conditions, such as dirt, which can accumulate on a camera lens, for example.

### SUMMARY

The object of the present disclosure, therefore, is to specify possible measures through which the above-mentioned disadvantages can be avoided.

One aspect of different embodiments of the disclosure is based on the recognition that sensors of an external mobile terminal device, such as image or acceleration sensors, can be used together with a vehicle, in other words as vehicle sensors. This is based on the recognition that, on the one hand, the accuracy and reliability of such sensors in mobile terminal devices has steadily improved in recent years, and on the other hand, many vehicle passengers now carry such mobile terminals with them.

The disclosure therefore relates to a method with which mobile devices can be integrated into a vehicle, as so-called smart devices (intelligent devices), to be able to use the sensors, in particular image sensors, that exist in these devices. Thus, the sensors of mobile terminal devices can be integrated into the sensor system of a vehicle, or linked thereto. For example, one or more sensors of one or more mobile devices can be used as vehicle sensors to control the vehicle, for example, to control the vehicle using an active parking system for parallel parking (parking assistant).

A method according to the disclosure that uses sensors of a mobile device with a vehicle has the characteristics described in more detail in the following, which can be carried out in the sequence in which they are described, but also in a different sequence as required. The disclosure is described hereafter based on the use of a mobile terminal device. Of course, a plurality of mobile devices in accordance with the disclosure can also be used, however.

In accordance with the disclosure, a mobile terminal device having one or a plurality of sensors and a vehicle are initially provided, wherein the vehicle has positioning facilities for the mobile device in or on the vehicle, and a processing unit.

A vehicle in this case is understood as meaning any mobile means of transport, i.e. both a terrestrial vehicle and a water-borne vehicle or aircraft, for example a passenger car. A mobile terminal device is a portable electronic terminal device, i.e. a device that is connected to a network node of a public or private data network or telecommunications network and can be used in a location-independent manner for voice, image or data communication or navigation. Such devices include mobile phones, smartphones, netbooks, notebooks or tablets.

Thereafter, the processing unit of the vehicle is connected to the mobile device and therefore also to its sensors, for example, by the vehicle driver, a vehicle passenger or other user registering the mobile terminal with the processing unit in the vehicle, e.g. through suitable application software (mobile app) of the mobile terminal device. The connection can be made through a data transmission network, for example, by wired or wireless means, for example in the form of a radio connection (wireless local area network - WLAN, Bluetooth, etc.), or an infrared connection.

After the connection is made, the mobile terminal can be identified using the processing unit, i.e. in a computer-assisted manner, in other words, the processing unit can determine, e.g. by querying an appropriate database or appropriate data of the mobile terminal itself, what type of device is being used (size, design type, water resistance, etc.) and which sensors are present in this device.

Based on this data, i.e. depending on the mobile device identified, positioning facilities for the mobile device in or on the vehicle, and usable sensors and functions implementable therewith, can be identified and output, i.e. proposed by the processing unit.

For example, the user, e.g., the vehicle driver or a vehicle passenger, can obtain a list of the positioning facilities. In addition, the list can comprise an inventory of the sensors that can be used in a specific positioning facility.

Positioning facilities are defined as possible connection and mounting points for the mobile device in or on the vehicle, to which the mobile device is mechanically fastened and/or secured, and from which communication with the processing unit of the vehicle is possible. The mounting should be effected in such a way that the mobile device can be positioned in a specific position, so that, for example, the image sensor of the mobile device can capture suitable images. For example, positioning facilities can be formed by slots into which the mobile device is inserted, or a holder can be provided, in which the mobile terminal is mounted.

Subsequently, the user selects a positioning facility and one or a plurality of sensors to be integrated into the sensor system of the vehicle, wherein the selection of sensors can be automatically linked to the selection of a positioning facility. For example, image sensors and/or acceleration sensors can be selected. In the case of image sensors, the mobile terminal is used as a camera, for example. The sensor selection can also be carried out indirectly by the user opting for a specific function (for example, active parking aid, parking distance control, etc.) and the processing unit then selecting the necessary sensors.

The user then positions the mobile terminal device in the selected positioning facility. In this case, an audible or visual signal can be issued, which directs the user to the selected positioning facility.

Measurements are then captured through the selected sensors and transferred to the processing unit of the vehicle. The measurements can include, for example, the velocity, acceleration, image signals, video signals, navigation signals such as GPS signals, or data concerning the distance to another object, e.g. ultrasonic or Lidar signals.

The transmitted measurements are processed, for example, evaluated through the processing unit. A suitable processing algorithm can be used for this, for example, an image processing algorithm, which can be provided, for example, by a cloud-based storage unit.

The measurements can be thereby integrated into the sensor system of the vehicle and can be used, for example, for autonomous vehicle functions, i.e. functions that are executed automatically by the vehicle itself, such as adhering to a certain distance from obstacles, or issuing warnings to the vehicle driver, for example, about the current speed, or relating to a parking operation (parallel parking aid).

The sensors of the mobile terminal can, for example, replace previously existing vehicle sensors or interact with them, enabling a more accurate sensing function. To this end, the respective measurement data from the sensors can be processed through a corresponding combination algorithm.

The connection of the vehicle to the mobile terminal also enables the application or programming of other functionalities or extensions to existing functionalities.

According to different design variants, a positioning facility inside or outside the vehicle can be selected. Also, if sensors of a plurality of mobile terminals are used with the vehicle, then a positioning facility within the vehicle can be selected for one or a plurality of mobile devices and a positioning facility outside the vehicle for other mobile devices.

Positioning facilities outside of the vehicle can be arranged, for example, at the front, rear or side of the vehicle where they are used, for example, for observing the environment through image sensors of cameras. Positioning facilities within the vehicle can be provided and selected for sensitive mobile devices, such as water- and/or shock-sensitive ones. They can be used, for example, for capturing measurements in which no direct contact with the vehicle environment is needed, such as speed, location determination etc.

In accordance with different design variants, the method may also comprise providing the positioned mobile device with power through a power supply device arranged in or on the positioning facility. As a result, a fault-free operation of the sensors can be ensured, which is particularly important in the case of safety-relevant sensors in which an interruption of the measurement acquisition would pose a security risk.

In accordance with other design variants, a verification of the correct positioning of the mobile terminal in the selected positioning facility can be provided. For example, a verification of the mechanical connection, the electrical connection and/or the data connection between the mobile terminal and the vehicle can be provided. If the mobile terminal has been positioned correctly, this can be signaled acoustically or visually. If no proper positioning is determined, an error message can be issued, for example, acoustically or visually. This procedure can ensure correct integration of the sensors of the mobile terminal into the sensor system of the vehicle and, for example, also help to ensure that a mobile terminal does not become detached from the positioning facility while driving, due to not having been positioned correctly.

In accordance with other design variants, the mobile terminal can be operated via a user interface arranged in the vehicle, such as a touch screen, a microphone, a keyboard, etc. For this purpose, the user interface can be connected to the mobile device in real time.

This can enable a continued use of the conventional functions of the mobile terminal (conventional mode), for example, the mobile terminal can continue to be used for making calls, reading, writing, establishing a connection to the internet, etc., although it is positioned in a positioning facility and the sensors are acquiring measurements and transmitting them to the processing unit of the vehicle (sensor mode). Sensor mode and conventional mode can thus be used at the same time.

However, it is also possible to provide that only one of the modes, i.e. conventional mode or sensor mode, can be used at a specific time. This may depend, for example, on the type of sensors, the performance of the mobile terminal and on the desired degree of support provided by the sensor system of the vehicle and the integrated sensors of the mobile terminal. For example, it can be provided that the sensor mode is only switched on during a parking maneuver.

In accordance with different design variants, the method can comprise transmitting a signal to the mobile terminal using the processing unit after terminating a driving operation. For example, it can be provided that the mobile terminal device receives a signal, for example when the engine is turned off or the ignition key is removed, whereupon the mobile terminal device emits a further signal, for example an acoustic or visual signal, to the user, e.g. in the form of a beep tone or flashing, to make the user aware that the mobile terminal device still needs to be removed from the positioning facility.

It can also be provided that the vehicle can only be locked if all mobile terminal devices have been removed from their positioning facilities, for example, by allowing the processing unit to only authorize locking after the mobile terminals have been removed again. In addition, after completing a driving operation the user can also be informed that he/she should remove all mobile terminal devices.

A vehicle according to the disclosure that uses sensors of a mobile terminal device has positioning facilities for the mobile terminal in or on the vehicle, and a processing unit. The processing unit can be connected to the mobile device and designed to identify the mobile device, propose positioning facilities, use sensors depending on the identified mobile device, and process measurements acquired and transmitted through sensors of the mobile device.

To output the proposed positioning facilities and reusable sensors, the vehicle can be provided with an output, such as a display or voice output. To connect the mobile terminal device to the processing unit and to transmit the measurements, a data transfer network (data communication network) can be provided.

For a more detailed explanation of the terms used, reference is made to the above remarks concerning the method.

In accordance with different design variants, the processing unit can be designed to process measurements acquired through image sensors and/or through acceleration sensors. Accordingly, the connectable mobile terminal can be provided with image sensors and/or acceleration sensors.

According to further design variants, the positioning facilities can be arranged inside or outside the vehicle. This enables a positioning of the mobile terminal inside or outside the vehicle, as previously described.

To provide a power supply for the mobile terminal, a power supply device for the mobile terminal can be arranged in or on the positioning facilities.

In accordance with other design variants, the vehicle can also have a user interface arranged in the vehicle, such as a touch screen, microphone, keyboard etc., to operate the mobile terminal.

In accordance with other design variants, the processing unit can be designed to transmit a signal to the mobile terminal after completing a driving operation.

A corresponding vehicle assistance system comprises a vehicle according to the disclosure and one or a plurality of mobile terminals with sensors, which are positioned in the positioning facilities and can be connected to the processing unit of the vehicle, so that the acquired measurements can be transmitted to the processing unit. For the transmission, the mobile terminals can be provided with a transmitting device, and the processing unit with a receiving device.

A computer program or computer program product according to the disclosure comprises commands, in response to which the processing unit of a vehicle according to the disclosure identifies a mobile terminal device, proposes positioning facilities for the mobile terminal device in or on the vehicle, sensors of the mobile terminal device that can be used depending on the mobile terminal device identified, and processes measurements acquired and transmitted through sensors of the mobile terminal device.

On a computer-readable medium according to the disclosure, or controller, a computer program according to the disclosure is stored.

The disclosure will be explained in further detail hereafter by reference to exemplary embodiments. The associated drawings show in:

### BRIEF DESCRIPTION OF THE DRAWINGS

FIG. 1 depicts an example flow diagram of a method according to the disclosure;

FIG. 2 depicts a schematic representation of an interaction between a vehicle according to the disclosure and a mobile terminal device;

FIG. 3 depicts a schematic representation of a vehicle according to the disclosure having mobile terminal devices.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

In the examples explained in the following, reference will be made to the attached drawings, which form part of these examples, and specific embodiments in which the disclosure may be realized are shown for illustration purposes. In this respect, directional terms such as “top”, “below”, “at the front”, “at the rear”, “frontal”, “rear”, etc. are used with respect to the orientation of the figures being described. Because components of embodiments can be positioned in a number of different orientations, the directional terminology is used for illustration purposes only, and is in no way restrictive.

It is understood that other embodiments can be used and structural or logical changes can be made without departing from the scope of protection of the present disclosure. It goes without saying that the features of the various exemplary embodiments described herein can be combined with one another, unless specifically stated otherwise. The following detailed description is therefore not to be understood in a restrictive sense, and the scope of protection of the present disclosure is defined by the attached claims. In the figures, identical or similar elements are labeled with identical reference numerals, where this is appropriate.

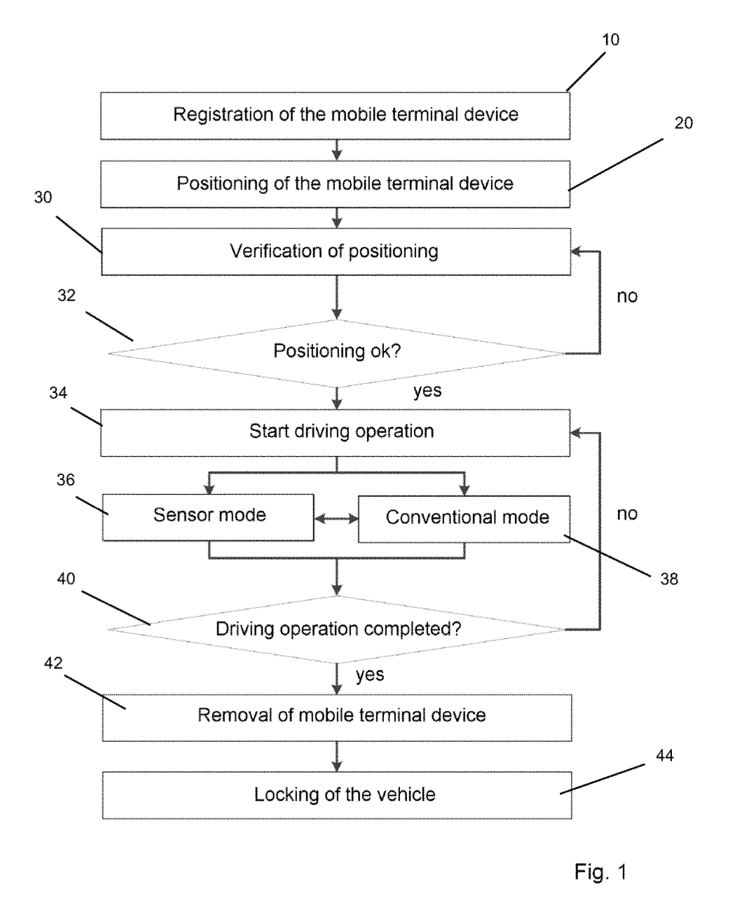

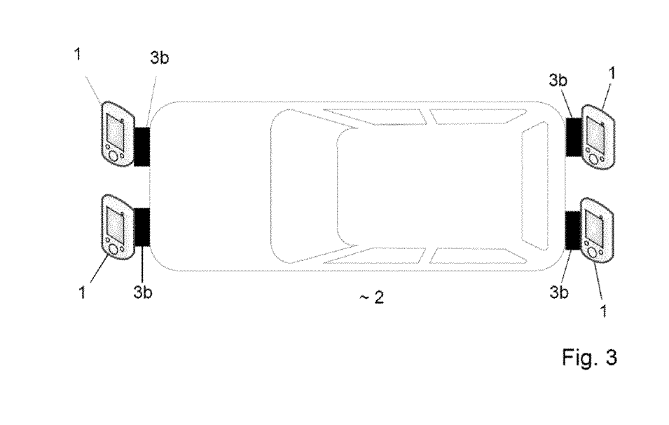

One exemplary embodiment, shown in FIG. 3, relates to use of sensors of four smartphones depicted entirely as mobile terminal devices 1 with a passenger car (car) as the vehicle 2. The smartphones 1 are positioned in positioning facilities 3 outside the vehicle 2. Image sensors of the smartphones are to be used to be able to observe a vehicle environment during a parking operation and, if necessary, to provide confirmation of a recommended execution of a parallel parking operation (active parking aid). FIG. 1 shows a schematic representation of the method sequence.

In FIG. 1, a first method step, designated a registration phase, comprises providing the smartphone 1 with the respective sensors and providing the car 2 at 10, which has positioning facilities 3b for the smartphone 1 available in or on the car 2. In addition, the car 2 has a processing unit 4.

During the registration phase at 10, the vehicle driver and/or the vehicle passengers register their smartphones 1 with an on-board computer, i.e. with the processing unit 4 of the vehicle 2. To achieve this, a dedicated piece of mobile application software can be used on the smartphones 1. A connection is therefore produced between the smartphones 1 and the processing unit 4, wherein the connection can be, for example, a wireless connection using WLAN.

On the basis of data exchanged between smartphones 1 and processing unit 4, the processing unit 4 can subsequently identify the smartphones 1 and propose positioning facilities 3 on the car 2 at 20. In addition, image sensors of the smartphone 1, cameras are also proposed as usable sensors and associated vehicle functions (such as active parking aid, distance control, etc.) are proposed at 20, which are to be implemented in the vehicle system. For example, this information can be output on a display or through voice output via a loudspeaker.

From the proposed positioning facilities 3 and sensors or functions, the vehicle driver and/or passengers select ones that will be used.

In a method step designated as a docking phase, the smartphones 1 are positioned in the selected positioning facilities 3 outside of the vehicle 2.

These positioning facilities 3 outside of the vehicle 2 have a mechanical connection facility, which allows the smartphones 1 to be securely fastened in a specified position, so that the image sensors can detect the vehicle's surroundings and the smartphones 1 are secured against slipping and falling out.

In addition, power supply devices 5 for the smartphones 1 are arranged in the positioning facilities 3, so that the smartphones 1 can be supplied with power. Optionally, a wired data transmission device can be provided, in which case the data exchange still takes place ostensibly via WLAN in a data communication network 7.

In a further method step, correct positioning of the smartphones 1 in the selected positioning facilities 3 is verified at 30. This comprises a verification at 30 of the mechanical and electrical connection. If the positioning is incorrect at 32, the vehicle driver and/or passenger is informed of this situation either acoustically or visually, for example, through a dedicated user interface 6, and is prompted to check or repeat the positioning step at 30.

If the positioning is correct at 32, this can be indicated via an optical or acoustic signal. A driving operation at 34 can now be started and the smartphones 1 are in a so-called driving mode at 34.

Within the driving mode the smartphones 1 can be operated in two different modes. The first to be used is called a sensor mode at 36, wherein measurements are acquired using selected sensors, transmitted to, and processed by the processing unit 4.

Secondly, the smartphones 1 can be operated in a conventional mode at 38, in which the actual smartphone features, such as calling, creating text messages, establishing a connection to the internet etc., can be used. For this purpose, one or a plurality of user interfaces 6, e.g. in the form of touch screens, can be positioned inside the vehicle 2, which are connected to the smartphones 1 in real-time, and used to operate the smartphones 1.

A parallel operation of the sensor mode 36 and the conventional mode 38 can also be provided. Alternatively, the sensor mode 36 can also be temporally limited and used only in certain situations, for example during a parking maneuver.

After completing the driving operation at 40, in a so-called undocking phase, the vehicle driver and/or passenger is informed, e.g. acoustically or visually through a user interface 6 arranged in the vehicle 2, that the smartphones 1 can be removed from the positioning facilities 3 again at 42. Optionally, it can be provided that the processing unit 4 transmits a signal to the smartphones 1, so that the smartphones 1 are, in turn, caused to emit audible or visual signals to inform the vehicle driver and/or passenger of removal of the smartphones 1 at 42.

After all smartphones 1 have been removed at 42, the processing unit 4 enables locking of the vehicle 2 at 44.

Of course, other mobile terminal devices 1, such as tablets, can be used instead of the smartphones.

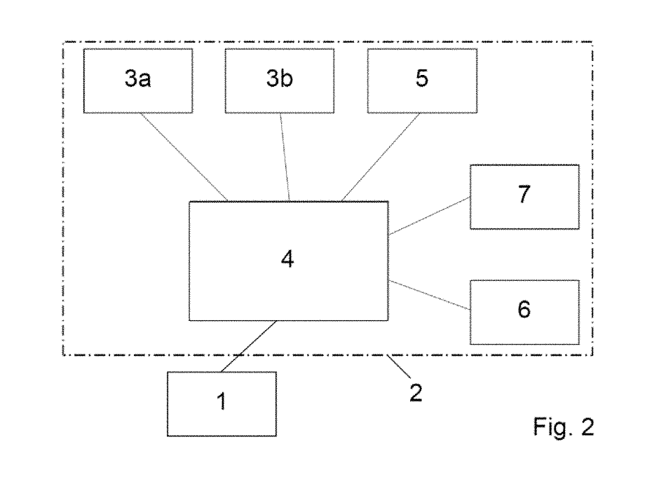

A vehicle 2 that can be used for the example method described or any other method according to the disclosure has the following elements, which are shown schematically in their context in FIG. 2.

The vehicle 2 has positioning facilities, 3a, 3b, both inside and outside the vehicle 2. The positioning facilities 3b outside of the vehicle 2 can be arranged in exposed places on the outer surface of the vehicle 2, such as the bodywork, and equipped with electrical and mechanical connection or mounting elements.

Furthermore, one or a plurality of power supply devices 5 is provided, which supply power in the positioning facilities 3a, 3b, and can supply power to mobile devices 1 positioned therein.

In addition, the vehicle 2 has one or a plurality of user interfaces 6, which can inform the driver, for example, of the status of the system and can be used to control the smartphone functionalities.

A data communications network 7 is provided for data transmission between the processing unit 4 and the mobile terminal device 1 and can be implemented, for example, as a wired network or a wireless network, e.g. WLAN.

For the coordination of all functions and evaluation of the measurements, among other functions, a processing unit 4 is provided, for example, an on-board computer.

The mobile terminal device 1 can be provided by all types of mobile devices, e.g. those belonging to the vehicle driver or passengers, which have suitable sensors and can be connected to the processing unit 4.

FIG. 3 shows a schematic representation of a vehicle 2 according to the disclosure together with four mobile terminal devices 1 having image sensors, e.g. in the form of smartphones belonging to a vehicle driver and three other passengers. The vehicle 2 has four positioning facilities 3 outside the vehicle 2. Of these, two are arranged on the front of the vehicle 2 and two on the rear of the vehicle 2, for example in the area of the headlights.

After identifying the mobile terminal 1 of the vehicle driver and the input information that a total of four mobile devices 1 is available, the processing unit 4 of the vehicle 2 proposes different positioning facilities 3 and functions that can be linked to these. Sensors are indirectly proposed via the functions.

Proposal 1: three-dimensional reverse parking assist system: two mobile devices 1 on the positioning facilities 3 on the rear of the vehicle 2;

Proposal 2: three-dimensional extended automatic parking assist system: four mobile devices 1 on the positioning facilities 3b on the front and rear of the vehicle 2;

Proposal 3: extended traffic congestion assist system: two mobile devices 1 on the positioning facilities 3b on the front of the vehicle 2;

Proposal 4: extended blind-spot monitoring: two mobile devices 1 on the positioning facilities 3b on the rear of the vehicle 2.

For example, the driver can then select proposal 1 and proposal 2, and three other passengers, e.g. by making a selection from a friend or contact list. The vehicle driver and the three other passengers will receive a notification on their mobile device 1 that instructs them to position their mobile device 1 in the appropriate positioning facility 3. In addition, they receive the instruction that the mobile devices 1 must be positioned in such a way that the main camera of the mobile terminal 1 is oriented towards a road.

After the mobile terminals 1 have been positioned, the driver and passengers enter the vehicle. The processing unit 4 checks connection to the mobile terminals 1, and starts the driving operation.

During the journey, the mobile terminals 1 are not needed, since the driver only wants parking assistance. As a result, passengers can use their mobile devices 1 in the conventional mode during the journey and control them, for example, through a display arranged in front of each seat.

As soon as the driver requests assistance when parking, the mobile terminal devices 1 are operated in the sensor mode. The image sensors of the cameras in the mobile devices 1, together with conventional ultrasonic sensors present in the vehicle 2, support a parking maneuver by the processing unit 4 generating a stereoscopic view of the vehicle environment by evaluation of measurement data from the image sensors and presenting it on a display. This increases the accuracy and convenience during the parking maneuver.

After the parking maneuver has been completed, the vehicle driver switches off an engine (not shown) of the vehicle 2. The user interface 6 outputs a signal to the vehicle driver and the passengers in the form of an alarm, to remind them to remove the mobile terminals 1 from the positioning facilities 3. Until the mobile terminals 1 have been removed, the vehicle 2 cannot be locked.

### LIST OF REFERENCE NUMERALS

1 mobile terminal device
2 vehicle
3 positioning facilities
3a positioning facilities inside the vehicle
3b positioning facilities outside the vehicle
4 processing unit
5 power supply device
6 user interface
7 data transmission network

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method that uses a mobile terminal device with a vehicle, comprising:
deploying a mobile terminal device that has sensors;
deploying a vehicle that has positioning facilities to attach the mobile terminal device in or on the vehicle, and a processing unit;
connecting the processing unit to the mobile terminal device;
identifying the mobile terminal device via the processing unit;
proposing positioning facilities for the mobile terminal device in or on the vehicle and sensors that can be used depending on the mobile terminal device identified through the processing unit;
selecting a positioning facility and sensors;
positioning the mobile terminal device in the selected positioning facility;
acquiring measurements using the selected sensors;
transmitting the acquired measurements to the processing unit; and
processing the transmitted measurement values through the processing unit.

2. The method as claimed in claim 1, wherein image sensors and/or acceleration sensors can be selected.

3. The method as claimed in claim 1, wherein selecting a positioning facility includes selecting a positioning facility inside or outside of the vehicle.

4. The method as claimed in claim 1 further comprising:
supplying the positioned mobile terminal device with power through a power supply device arranged in or on the positioning facility.

5. The method as claimed in claim 1 further comprising:
verifying a correct positioning of the mobile terminal device in the selected positioning facility.

6. The method as claimed in claim 1, wherein the mobile terminal device is operated through a user interface arranged in the vehicle.

7. The method as claimed in claim 1 further comprising:
transmitting a signal to the mobile terminal device through the processing unit after completion of a driving operation.

8. A vehicle compatible with sensors of a mobile device, comprising:
positioning facilities that attach the mobile device on the vehicle; and
a processing unit connected to the mobile device and configured to identify the mobile device, to propose positioning facilities and sensors to be used based on an identified mobile device, and to process measurements acquired and transmitted through sensors of the mobile device.

9. The vehicle as claimed in claim 8, wherein the processing unit processes measurements acquired through image sensors and acceleration sensors.

10. The vehicle as claimed in claim 8, wherein the positioning facilities are arranged inside or outside the vehicle.

11. The vehicle as claimed in claim 8 further comprising a power supply device, for the mobile terminal device, arranged in or on positioning facilities.

12. The vehicle as claimed in claim 8 further comprising:
a user interface arranged in the vehicle to operate the mobile device.

13. The vehicle as claimed in claim 8, wherein the processing unit is further configured to transmit a signal to the mobile terminal device after an end of a driving operation.

14. A park assist system for a vehicle, comprising:
a controller configured to, in response to an identified mobile terminal device, propose positioning facilities that attach the mobile terminal device on the vehicle and sensors of the identified mobile terminal device, and start a driving operation based on processed measurements acquired and transmitted through the sensors of the mobile terminal device.

15. The park assist system as claimed in claim 14, wherein the controller, via a power supply, is further configured to supply power to the mobile terminal device arranged in the positioning facilities.

16. The park assist system as claimed in claim 14 further comprising a user interface arranged in the vehicle to operate the mobile terminal device.

17. The park assist system as claimed in claim 14, wherein the controller is further configured to transmit a signal to the mobile terminal device after completion of the driving operation.

18. The park assist system as claimed in claim 14, wherein the controller is further configured to verify a correct positioning of the mobile terminal device in the positioning facility.
